(19) United States
(12) Patent Application Publication
(10) Pub. No.: US 2026/0129354 A1
(43) Pub. Date: May 7, 2026

(54) ELECTRONIC DEVICE INCLUDING ACOUSTIC MODULE

(71) Applicant: SAMSUNG ELECTRONICS CO., LTD., Suwon-si (KR)

(72) Inventors: Joonrae CHO, Suwon-si (KR); Kiwon KIM, Suwon-si (KR); Donghyun KIM, Suwon-si (KR); Myeungseon KIM, Suwon-si (KR); Myungcheol LEE, Suwon-si (KR)

(21) Appl. No.: 19/441,991

(22) Filed: Jan. 7, 2026

Related U.S. Application Data
(63) Continuation of application No. PCT/KR2024/007658, filed on Jun. 4, 2024.

(30) Foreign Application Priority Data
Aug. 7, 2023 (KR) 10-2023-0103138
Oct. 6, 2023 (KR) 10-2023-0133624

(51) Int. Cl. H04R 1/28; H04R 1/02

(52) U.S. Cl. CPC H04R 1/288; H04R 1/025; H04R 1/028; H04R 1/2811; H04R 2499/11; H04R 2499/15

(57) ABSTRACT

An electronic device includes a housing and an acoustic module disposed inside the housing. The acoustic module may include: a speaker unit including a vibrating plate; a speaker enclosure for accommodating the speaker unit; a porous air-adsorbing member disposed inside the speaker enclosure; and an air-permeable shock-absorbing member that is disposed inside the speaker enclosure and stacked with the air-adsorbing member.

### CROSS-REFERENCE TO RELATED APPLICATIONS

This application is a continuation application, claiming priority under § 365(c), of an International application No. PCT/KR2024/007658, filed on Jun. 4, 2024, which is based on and claims the benefit of a Korean patent application number 10-2023-0103138, filed on Aug. 7, 2023, in the Korean Intellectual Property Office, and of a Korean patent application number 10-2023-0133624, filed on Oct. 6, 2023, in the Koran Intellectual Property Office, the disclosure of each of which is incorporated by reference herein in its entirety.

### BACKGROUND

### 1. Field

An embodiment of the disclosure relates to an electronic device including an acoustic device.

### 2. Description of Related Art

Due to the remarkable development of information communication technology and semiconductor technology, the distribution and use of various electronic devices are rapidly increasing. In particular, recent electronic devices are being developed to be portable and capable of communication.

The term “electronic device” may refer to a device that performs a specific function based on an installed program, such as a home appliance, an electronic scheduler, a portable multimedia player, a mobile communication terminal, a tablet PC, a video/audio device, a desktop/laptop PC, or a vehicle navigation system. The above-mentioned electronic devices may output, for example, information stored therein as audio or video.

An electronic device may include at least one speaker module to output various sounds. The speaker module may output sound signals audible to the user by converting electrical signals generated in the electronic device into sound signals using vibration of a diaphragm.

The above-described information may be provided as related art for the purpose of helping to understand the disclosure. No claim or determination is made as to whether any of the foregoing may be applied as prior art with respect to the disclosure.

### SUMMARY

An electronic device according to an embodiment of the disclosure may include a housing and an acoustic module disposed inside the housing. The acoustic module may include a speaker unit including a diaphragm, a speaker enclosure accommodating the speaker unit, a porous air-absorbing member disposed inside the speaker enclosure, and a breathable buffer member disposed inside the speaker enclosure and stacked with the air-absorbing member.

An electronic device according to an embodiment of the disclosure may include a housing and an acoustic module disposed inside the housing. The acoustic module may include a speaker unit including a diaphragm, a speaker enclosure accommodating the speaker unit, a resonance space formed inside the speaker enclosure, a porous air-absorbing member disposed inside the speaker enclosure and configured to perform negative air absorption or positive air absorption in the resonance space by vibration of the diaphragm, and a breathable buffer member including a foaming agent and disposed between the air-absorbing member and the speaker enclosure inside the speaker enclosure.

### BRIEF DESCRIPTION OF DRAWINGS

FIG. 1 is a block diagram of an electronic device in a network environment, according to an embodiment disclosed herein.

FIG. 2 is a perspective view illustrating a front side of an electronic device according to an embodiment disclosed herein.

FIG. 3 is a perspective view illustrating a rear side of the electronic device of FIG. 3 according to an embodiment disclosed herein.

FIG. 4A is an exploded perspective view illustrating a front side of the electronic device of FIG. 2, according to an embodiment disclosed herein.

FIG. 4B is an exploded perspective view illustrating a rear side of the electronic device of FIG. 2, according to an embodiment disclosed herein.

FIG. 5 is an exploded perspective view of an acoustic module according to an embodiment disclosed herein.

FIG. 6 is a cross-sectional view taken along line A-A′ of the acoustic module of FIG. 5 according to an embodiment disclosed herein.

FIG. 7 is a partially enlarged view of the acoustic module according to an embodiment disclosed herein.

FIG. 8 is a view illustrating a molecular structure of an air-absorbing member according to various embodiments of the disclosure.

FIGS. 9 to 11 are cross-sectional views illustrating an air-absorbing member and a buffer member inside an acoustic module according to an embodiment disclosed herein.

FIGS. 12 to 14 are cross-sectional views illustrating a portion of an electronic device in which a speaker enclosure and a housing are integrally formed according to an embodiment disclosed herein.

### DETAILED DESCRIPTION

The electronic device according to the embodiments disclosed herein may be in the form of a single device. The electronic device may include, for example, a portable communication device (e.g., a smartphone), a computer device, a portable multimedia device, a portable medical device, a camera, a wearable device, or a home appliance. The electronic devices according to the embodiments disclosed herein are not limited to the above-described devices.

Various embodiments of the disclosure and terms used herein are not intended to limit the technical features disclosed herein to specific embodiments, and are to be understood to include various modifications, equivalents, or substitutions thereof. In relation to the description of the drawings, similar reference numerals may be used for similar or related components. The singular form of a noun corresponding to an item may include one item or a plurality of items unless the context clearly indicates otherwise. In the disclosure, each of phrases, such as “A or B,” “at least one of A and B,” “at least one of A or B,” “A, B, or C,” “at least one of A, B, and C,” and “at least one of A, B, or C” may include any one of the items listed together in the corresponding phrase or all possible combinations of the items. Terms such as “1^{st},” “2^{nd},” “first,” and “second” may be used to simply distinguish a given component from other corresponding components and do not limit the corresponding components in other aspects (e.g., importance or order). When a certain (e.g., a first) component is mentioned as being “coupled” or “connected” to another (e.g., a second) component, with or without a term “functionally” or “communicatively,” it means that the certain component may be connected to the other component directly (e.g., wiredly), wirelessly, or via a third component.

The term “module” used in an embodiment of the disclosure may include a unit implemented in hardware, software, or firmware, and may be used interchangeably with terms such as “logic,” “logic block,” “component,” or “circuit.” The module may be an integrally configured component or a minimum unit or a portion of the component, which performs one or more functions. For example, according to an embodiment, the module may be implemented in the form of an application-specific integrated circuit (ASIC).

According to an embodiment, each of the above-described components (e.g., a module or a program) may include either a single entity or multiple entities, and some of the multiple entities may be separately disposed in other components. According to an embodiment, one or more of the components or operations described above may be omitted, or one or more other components or operations may be added. Alternatively, or additionally, multiple components (e.g., modules or programs) may be integrated into a single component. In such a case, the integrated component may perform one or more functions of each of the multiple components in the same or a similar manner as performed by the corresponding one of the multiple components before the integration. According to an embodiment, operations performed by a module, a program, or other components may be executed sequentially, in parallel, repetitively, or heuristically, and one or more of the operations may be executed in a different order or omitted, or one or more other operations may be added.

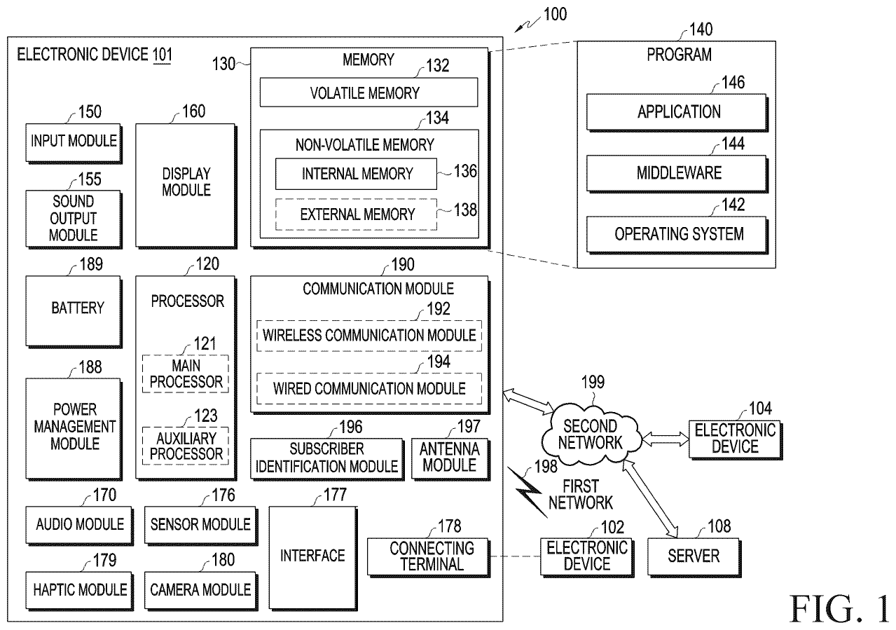

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that an embodiment of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment as set forth herein may be implemented as software (e.g., the program) including one or more instructions that are stored in a storage medium (e.g., internal memory 136 or external memory 138) that is readable by a machine (e.g., the electronic device). For example, a processor (e.g., the processor) of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

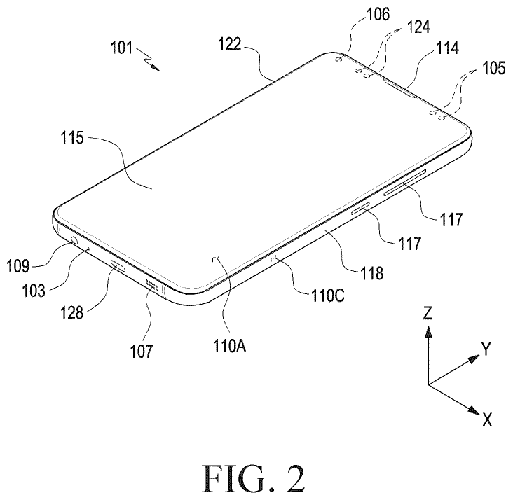

FIG. 2 is a perspective view illustrating a front side of an electronic device 101 according to various embodiments disclosed herein.

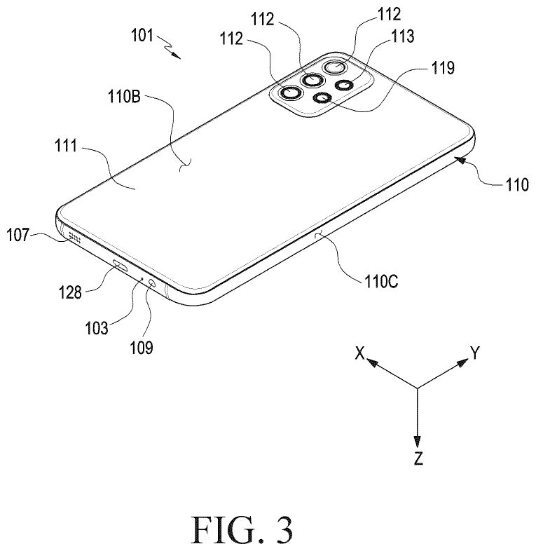

FIG. 3 is a perspective view illustrating a rear side of the electronic device 101 of FIG. 3 according to an embodiment disclosed herein.

Referring to FIGS. 2 and 3, the electronic device 101 (e.g., the electronic device 101 in FIG. 1) according to an embodiment may include a housing 110 including a first surface (or the front surface) 110A, a second surface (or the rear surface) 110B, and a side surface 110C surrounding the space between the first surface 110A and the second surface 110B. In an embodiment (not illustrated), the housing 110 may refer to a structure that forms a portion of the first surface 110A of FIG. 2, and the second surface 110B and the side surface 110C of FIG. 3.

According to an embodiment, at least a portion of the first surface 110A may be defined by a substantially transparent front surface plate 122 (e.g., a glass plate or a polymer plate including various coating layers). The second surface 110B may be defined by a substantially opaque rear surface plate 111. The rear surface plate 111 may be formed of, for example, coated or colored glass, ceramic, polymer, metal (e.g., aluminum, stainless steel (STS), or magnesium), or a combination of two or more of these materials. The side surface 110C may be defined by a side surface structure (or a “side surface bezel structure”) 118 coupled to the front surface plate 122 and the rear surface plate 111 and including metal and/or polymer. In an embodiment, the rear surface plate 111 and the side surface structure 118 may be integrally formed and may include the same material (e.g., a metal material such as aluminum).

According to an embodiment, the front surface plate 122 may include one or more areas curved and extending seamlessly from at least a portion of an edge toward the rear surface plate 111. For example, the front surface plate 122 (or the rear surface plate 111) may include only one of the areas curved and extending toward the rear surface plate 111 (or the front surface plate 122), at one side edge of the first surface 110A. According to an embodiment, the front surface plate 122 or the rear surface plate 111 may have a substantially flat plate shape, and in this case, may not include a curved and extending area. When the front surface plate 122 or the rear surface plate 111 includes a curved and extending area, the thickness of the electronic device 101 at the portion where the curved extension area is included may be smaller than the thickness at other portions.

According to an embodiment, the electronic device 101 may include at least one of a display 115, an audio module (e.g., a microphone hole 103, an external speaker hole 107, and a call receiver hole 114), a sensor module (e.g., a first sensor module 124, a second sensor module (not illustrated), and a third sensor module 119), a camera module (e.g., a first camera device 105, a second camera device 112, and a flash 113), key input devices 117, a light-emitting element 106, and connector holes (e.g., a first connector hole 128 and a second connector hole 109). In an embodiment, at least one of the components (e.g., the key input devices 117 or the light-emitting element 106) may be omitted from the electronic device 101 or other components may be additionally included.

The display 115 may output a screen or may be visually exposed through, for example, a substantial portion of the first surface 110A (e.g., the front surface plate 122). In an embodiment, at least a portion of the display 115 may be visually exposed through the front surface plate 122 forming the first surface 110A or through a portion of the side surface 110C. In an embodiment, a corner of the display 115 may be formed to be substantially the same as the outer shape of the front surface plate 122 adjacent thereto. In an embodiment (not illustrated), the distance between the periphery of the display 115 and the periphery of the front surface plate 122 may be substantially constant in order to enlarge the visually exposed area of the display 115.

According to an embodiment, recesses or openings 333 may be provided in some portions of the screen display area of the display 115, and at least one of an audio module (e.g., the call receiver hole 114), a sensor module (e.g., the first sensor module 124), a camera module (e.g., the first camera module 105), and a light-emitting element 106 may be aligned with the recesses or the openings 333. In an embodiment (not illustrated), the rear surface of the screen display area of the display 115 may include at least one of an audio module (e.g., the call receiver hole 114), a sensor module (e.g., the first sensor module 124), a camera module (e.g., the first camera device 105), a fingerprint sensor (not illustrated), and a light-emitting element 106. In an embodiment (not illustrated), the display 115 may be coupled to or disposed adjacent to a touch-sensitive circuit, a pressure sensor capable of measuring a touch intensity (pressure), and/or a digitizer configured to detect a magnetic field-type stylus pen.

According to an embodiment, the audio module (e.g., microphone hole 103, external speaker hole 107, call receiver hole 114) may include a microphone hole 103 and speaker holes (e.g., the external speaker hole 107 and the call receiver hole 114). A microphone configured to acquire external sound may be disposed inside the microphone hole 103.In an embodiment, multiple microphones may be disposed to detect the direction of sound. The speaker holes may include the external speaker hole 107 and the call receiver hole 114. In an embodiment, the speaker holes (e.g., the external speaker hole 107 and the call receiver hole 114) and the microphone hole 103 may be implemented as a single hole, or a speaker may be included without the speaker holes (e.g., the external speaker hole 107 and the call receiver hole 114) (e.g., a piezo speaker).

According to an embodiment, the sensor modules may generate electrical signals or data values corresponding to an internal operating state or an external environmental state of the electronic device 101. The sensor modules may include, for example, a first sensor module 124 (e.g., a proximity sensor) and/or a second sensor module (not illustrated) (e.g., a fingerprint sensor) disposed on the first surface 110A of the housing 110, and/or a third sensor module 119 disposed on the second surface 110B of the housing 110. The second sensor module (not illustrated) (e.g., a fingerprint sensor) may be disposed not only on the first surface 110A (e.g., the display 115) of the housing 110, but also on the second surface 110B or the side surface 110C of the housing 110. The electronic device 101 may further include at least one of, for example, a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor 124.

According to an embodiment, the camera module may include a first camera device 105 disposed on the first surface 110A of the electronic device 101, and a second camera device 112 and/or a flash 113 disposed on the second surface 110B of the electronic device 101. The camera devices (e.g., the first camera device 105 and the second camera device 112) may include one or more lenses, an image sensor, and/or an image signal processor. The flash 113 may include, for example, a light-emitting diode or a xenon lamp. In an embodiment, one or more lenses (e.g., an infrared camera lens, a wide-angle lens, and a telephoto lens) and image sensors may be disposed on one surface of the electronic device 101. In an embodiment, the flash 113 may emit infrared light, and the infrared light emitted by the flash 113 and reflected by a subject may be received through the third sensor module 119. The electronic device 101 or a processor (e.g., the processor 120 in FIG. 1) of the electronic device 101 may detect depth information of a subject based on a time point when the infrared light is received by the third sensor module 119.

According to an embodiment, the key input devices 117 may be disposed on the side surface 110C of the housing 110. In an embodiment, the electronic device 101 may not include some or all of the above-described key input devices 117, and a key input device 117 not included may be implemented in another form, such as a soft key, on the display 115. In an embodiment, the key input devices may include a sensor module disposed on the second surface 110B of the housing 110.

According to an embodiment, the light-emitting element 106 may be disposed on, for example, the first surface 110A of the housing 110. The light-emitting elements 106 may provide, for example, the state information of the electronic device 101 in the form of light. In an embodiment, the light-emitting element 106 may provide a light source that operates in conjunction with, for example, the operation of the camera module (e.g., the first camera device 105). The light-emitting elements 106 may include, for example, a light emitting diode (LED), an infrared light emitting diode (IR LED), and a xenon lamp.

According to an embodiment, the connector holes (e.g., a first connector hole 128 and a second connector hole 109) may include a first connector hole 128 configured to accommodate a connector (e.g., a USB connector) configured to transmit/receive power and/or data with an external electronic device (e.g., the electronic device 1002 in FIG. 1), and/or a second connector hole (e.g., an earphone jack) 109 configured to accommodate a connector configured to transmit/receive an audio signal with an external electronic device.

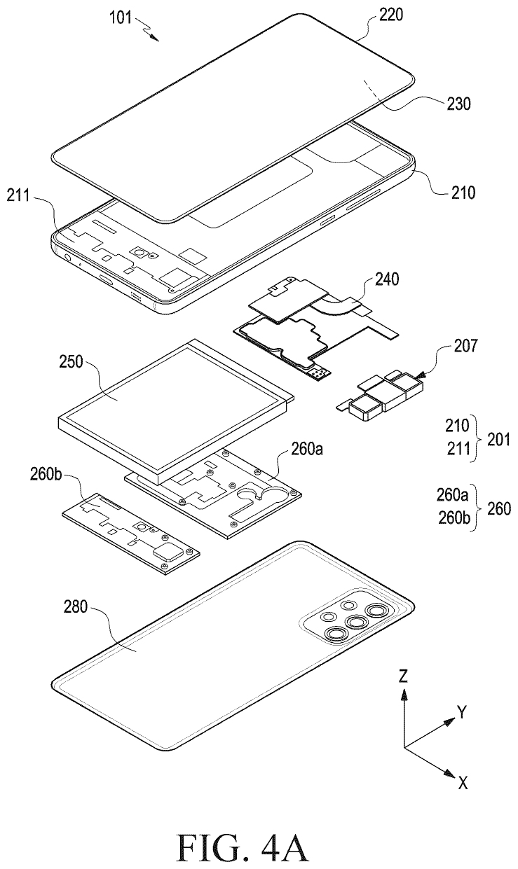

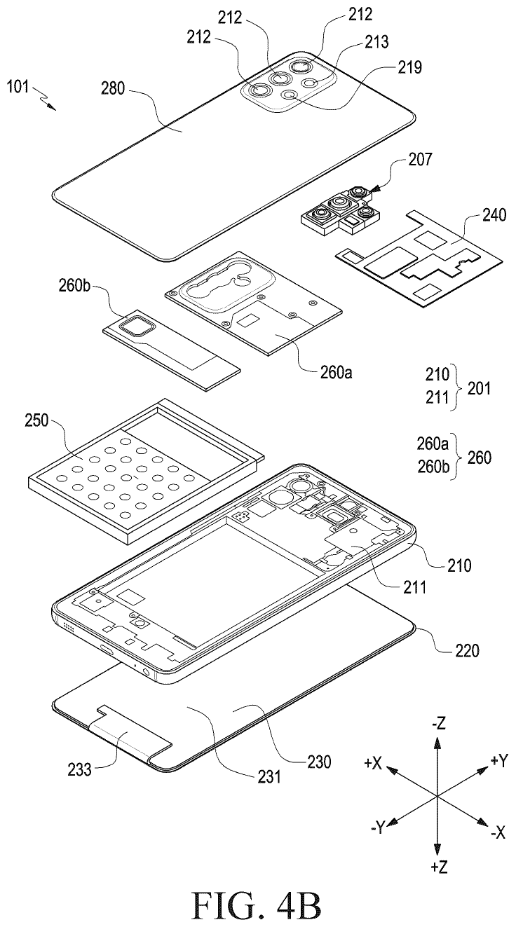

FIG. 4A is an exploded perspective view illustrating a front side of the electronic device 101 of FIG. 2, according to an embodiment disclosed herein.

FIG. 4B is an exploded perspective view illustrating a rear side of the electronic device 101 of FIG. 2, according to an embodiment disclosed herein.

Referring to FIGS. 4A and 4B, the electronic device 101 (e.g., the electronic device 101 of FIGS. 1, 2, or 3) may include a side surface structure 210, a first support member 211 (e.g., a bracket), a front surface plate 220 (e.g., the front surface plate 122 of FIG. 2), a display 230 (e.g., the display 115 of FIGS. 2 and 3), a printed circuit board (or a substrate assembly) 240, a battery 250, a second support member 260 (e.g., a rear case), an antenna, a camera assembly 207, and a rear surface plate 280 (e.g., the rear surface plate 111 of FIG. 3).

According to an embodiment, at least one of the components (e.g., the first support member 211 or the second support member 260) may be omitted from the electronic device 101, or may additionally include other components. At least one of the components of the electronic device 101 may be the same as or similar to at least one of the components of the electronic device 101 illustrated in FIG. 2 or FIG. 3, and redundant descriptions are omitted below.

According to an embodiment, the first support member 211 may be disposed inside the electronic device 101 to be connected to the side surface structure 210, or may be integrated with the side surface structure 210. The first support member 211 may be made of, for example, a metal material and/or a non-metal (e.g., polymer) material. When at least partially made of a metal material, a portion of the side surface structure 210 or the first support member 211 may serve as an antenna. The first support member 211 may include one surface to which the display 230 is coupled and the other surface to which the printed circuit board 240 is coupled. A processor (e.g., the processor 120 in FIG. 1), memory (e.g., the memory 130 in FIG. 1), and/or an interface (e.g., the interface 177 in FIG. 1) may be mounted on the printed circuit board 240. The processor may include one or more of, for example, a central processing unit (CPU), an application processor, a graphics processing unit (GPU), an image signal processor, a sensor hub processor, or a communication processor.

According to an embodiment, the first support member 211 and the side surface structure 210 may be combined to be referred to as a front case or a housing 201. According to an embodiment, the housing 201 may be generally understood as a structure for accommodating, protecting, or positioning the printed circuit board 240 or the battery 250. In an embodiment, it may be understood that the housing 201 includes structures capable of being visually or tactually recognized by a user in the exterior of the electronic device 101, such as the side surface structure 210, the front surface plate 220, and/or the rear surface plate 280. In an embodiment, the “front surface or rear surface of the housing 201” may be understood as the first surface 110A in FIG. 2 or the second surface 110B in FIG. 3. In an embodiment, the first support member 211 may be disposed between the front surface plate 220 (e.g., the first surface 110A in FIG. 2) and the rear surface plate 280 (e.g., the second surface 110B in FIG. 3) and may serve as a structure on which electrical/electronic components, such as a printed circuit board 240 or a camera assembly 207, are arranged.

According to an embodiment, the display 230 may include a display panel 231 and a flexible printed circuit board 233 extending from the display panel 231. The flexible printed circuit board 233 may be understood, for example, to be electrically connected to the display panel 231 while being disposed at least partially on the rear surface of the display panel 231. In an embodiment, reference numeral “231” may be understood as denoting a protective sheet disposed on the rear surface of the display panel. For example, unless otherwise classified in the following detailed description, the protective sheet may be understood as being a portion of the display panel 231. In an embodiment, the protective sheet may function as a buffer structure (e.g., a low-density elastic material such as a sponge), which can absorb an external force or an electromagnetic shield structure (e.g., a copper (Cu) sheet). According to an embodiment, the display 230 may be disposed on the inner surface of the front surface plate 220 and may include a light-emitting layer to output a screen through at least a portion of the first surface 110A of FIG. 2 or the front surface plate 220. As mentioned above, the display 230 may output a screen through substantially the entire area of the first surface 110A of FIG. 2 or the front surface plate 220.

According to an embodiment, the memory may include, for example, volatile memory or non-volatile memory.

According to an embodiment, the interface may include, for example, a high-definition multimedia interface (HDMI), a universal serial bus (USB) interface, an Secure Digital (SD) card interface, and/or an audio interface. For example, the interface may electrically or physically connect the electronic device 101 to an external electronic device, and may include a USB connector, an SD card connector, a multimedia card (MMC) connector, or an audio connector.

According to an embodiment, the second support member 260 may include, for example, an upper support member 260a and a lower support member 260b. In an embodiment, the upper support member 260a may be disposed to surround the printed circuit board 240 together with a portion of the first support member 211. A circuit device implemented in the form of an integrated circuit chip (e.g., a processor, a communication module, or memory) or various electrical/electronic components may be disposed on the printed circuit board 240, and in some embodiments, the printed circuit board 240 may be provided with an electromagnetic shielding environment from the upper support member 260a. In an embodiment, the lower support member 260b may serve as a structure for positioning electric/electronic components such as a speaker module and an interface (e.g., a USB connector, an SD card/MMC connector, or an audio connector). In an embodiment, electrical/electronic components, such as a speaker module and an interface (e.g., a USB connector, an SD card/MMC connector, or an audio connector), may be disposed on an additional printed circuit board (not illustrated). In this case, the lower support member 260b may be disposed to enclose the additional printed circuit board together with the other portion of the first support member 211. The speaker module or interface disposed on the additional printed circuit board (not illustrated) or the lower support member 260b may be arranged to correspond to the audio module of FIG. 2 (e.g., the microphone hole 103 or the speaker holes (e.g., the external speaker hole 107 and the call receiver hole 114)) or the connector holes (e.g., the first connector hole 128 and the second connector hole 109).

According to an embodiment, the battery 250 may serve as a device that supplies power to at least one component of the electronic device 101, and may include, for example, a non-rechargeable primary cell, a rechargeable secondary cell, or a fuel cell. At least a portion of the battery 250 may be disposed on substantially the same plane as, for example, the printed circuit board 240. The battery 250 may be integrally disposed inside the electronic device 101 or may be detachably disposed with respect to the electronic device 101.

Although not illustrated, the antenna may include a conductor pattern implemented on the surface of the second support member 260 through, for example, a laser direct structuring method. In an embodiment, the antenna may include a printed circuit pattern provided on the surface of a thin film, and the thin film-type antenna may be disposed between the rear surface plate 280 and the battery 250. The antenna may include, for example, a near-field communication (NFC) antenna, a wireless charging antenna, and/or a magnetic secure transmission (MST) antenna. The antenna may, for example, perform near-field communication with an external device, or wirelessly transmit and receive power required for charging. In an embodiment, an antenna structure may be configured with a portion or a combination of the side surface structure 210 and/or the first support member 211.

According to an embodiment, the camera assembly 207 may include at least one camera module. Inside the electronic device 101, the camera assembly 207 may receive at least some of light incident through optical holes or camera windows 212, 213, and 219. In an embodiment, the camera assembly 207 may be disposed on the first support member 211 at a position adjacent to the printed circuit board 240. In an embodiment, the camera modules of the camera assembly 207 may be generally aligned with one of the camera windows 212, 213, and 219, and may be at least partially surrounded by the second support member 260 (e.g., the upper support member 260a).

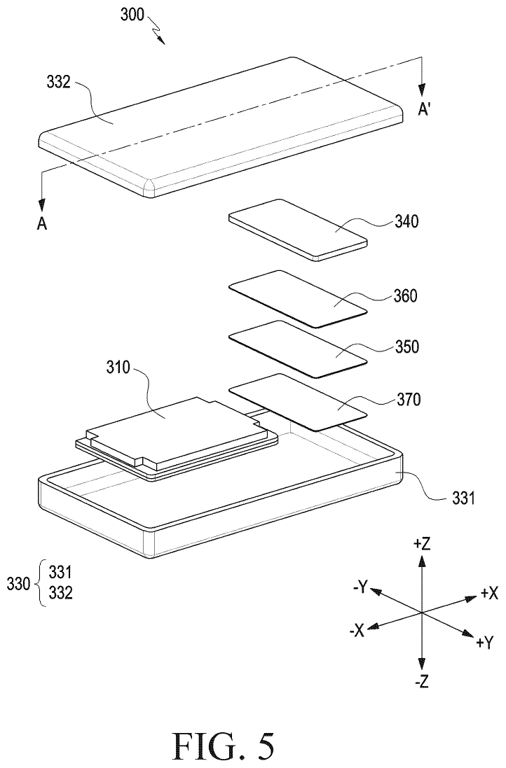

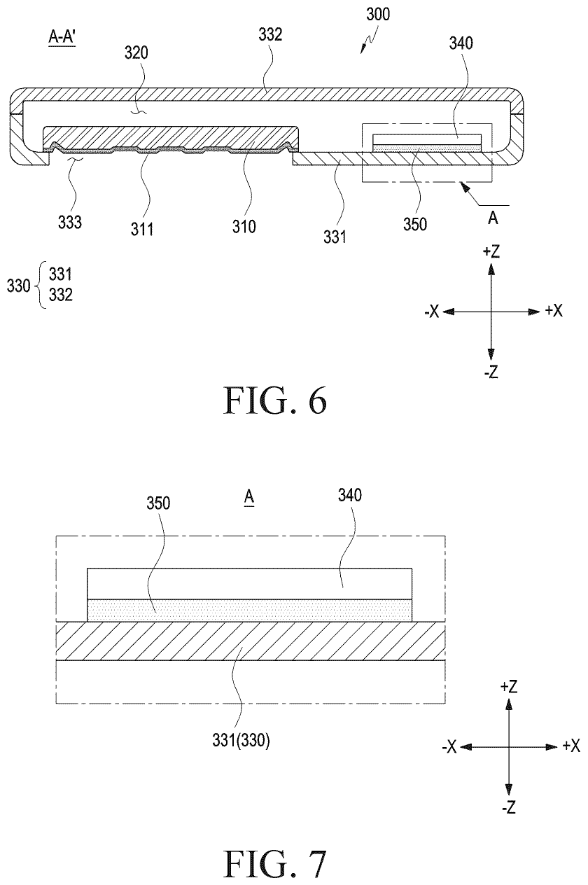

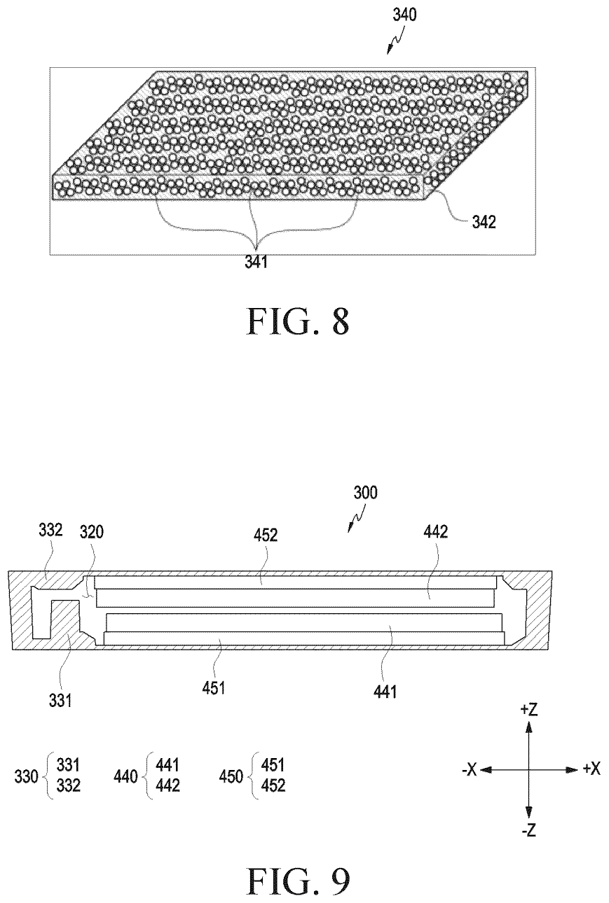

FIG. 5 is an exploded perspective view of an acoustic module 300 according to an embodiment disclosed herein. FIG. 6 is a cross-sectional view taken along line A-A′ of the acoustic module 300 of FIG. 5 according to an embodiment disclosed herein. FIG. 7 is a partially enlarged view of the acoustic module 300 according to an embodiment disclosed herein.

Referring to FIGS. 5 to 7, the electronic device 101 may include a housing 301 and an acoustic module 300 disposed inside the housing 301. The configurations of the housing 301 and the acoustic module 300 of FIGS. 5 to 7 may be entirely or partially the same as the configurations of the housing 110 and 201 of FIGS. 2 to 4B and the acoustic output module 155 of FIG. 1. The structures illustrated in FIGS. 5 to 7 may be selectively combined with the structures illustrated in FIGS. 2 to 4B.

According to an embodiment, the acoustic module 300 may include a speaker unit 310 configured to generate sound based on an electrical signal, and a speaker enclosure 330 configured to accommodate the speaker unit 310.

According to an embodiment, the speaker unit 310 may convert an electrical signal into sound. According to an embodiment, the speaker unit 310 may include at least one of a coil (e.g., a voice coil) (not illustrated) configured to vibrate a diaphragm 311 based on pulse width modulation (PWM), a diaphragm 311 configured to vibrate, a damping member (e.g., a spring) (not illustrated) formed of a conductive material and configured to deliver a signal (e.g., power) transmitted from outside the acoustic module 300 to the coil, a magnet (not illustrated), or a conductive plate (not illustrated) configured to concentrate a magnetic field generated from the magnet.

According to an embodiment, the diaphragm 311 may be disposed toward a lower direction (in the-Z-axis direction) of the speaker unit 310.

According to an embodiment, the speaker enclosure 330 may form at least a portion of an outer surface of the acoustic module 300. For example, the speaker enclosure 330 may accommodate the speaker unit 310. For example, an internal space of the speaker enclosure 330 accommodating the speaker unit 310 and an external space thereof may be acoustically separated from each other. For example, the speaker enclosure 330 may prevent sound emitted in a direction in which the diaphragm 311 of the speaker unit 310 is disposed from overlapping with sound emitted in an opposite direction to the direction in which the diaphragm 311 is disposed. According to an embodiment, the speaker enclosure 330 may include a first enclosure housing 331 disposed at a lower side (in the-Z direction) and a second enclosure housing 332 disposed at an upper side (in the +Z direction) and coupled to the first enclosure housing 331. For example, the first enclosure housing 331 and the second enclosure housing 332 may have a structure coupled by vibration. For example, the first enclosure housing 331 and the second enclosure housing 332 may have a structure coupled by adhesion. For example, the first enclosure housing 331 and the second enclosure housing 332 may be coupled by an external force.

According to an embodiment, the speaker enclosure 330 may further include a protective cover (not illustrated) configured to protect the diaphragm 311, a yoke configured to protect a component (e.g., a magnet) of the speaker unit 310, or a radiation hole (not illustrated) configured to transmit vibration generated by the speaker unit 310 to the outside of the electronic device. For example, the speaker enclosure 330 may refer to a housing or casing surrounding the speaker unit 310.

According to an embodiment, the second enclosure housing 332 may further include an opening 333 in a portion in contact with the speaker unit 310. The opening 333 may be covered by the diaphragm 311 and may serve as a sound output port that provides a space to facilitate vibration of the diaphragm 311 while allowing sound to be emitted to the outside of the acoustic module 300.

According to an embodiment, at least a portion of the speaker enclosure 330 may be used as a resonator configured to accumulate at least a part of the sound generated by the speaker unit 310. According to an embodiment, the acoustic module 300 may include a resonance space 320 formed inside the speaker enclosure 330. According to an embodiment, the resonance space 320 may be a space surrounded by an inner surface of the speaker enclosure 330 and the speaker unit 310 inside the speaker enclosure 330. According to an embodiment, the resonance space 320 may be an empty space inside the speaker enclosure 330, in which sound resonance may occur. At least a portion of the amplitude of vibration generated from the speaker unit 310 may be amplified in the resonance space 320.

According to an embodiment, the acoustic module 300 may further include an air-absorbing member 340 disposed inside the speaker enclosure 330 and configured to minimize air resistance against vibration of the diaphragm 311.

According to an embodiment, the air-absorbing member 340 may be disposed on either the first enclosure housing 331 or the second enclosure housing 332. For example, the air-absorbing member 340 may be disposed on the first enclosure housing 331. For example, the air-absorbing member 340 may be disposed on the second enclosure housing 332. The air-absorbing member 340 may be disposed on the same plane (XY plane) as and spaced apart from the speaker unit 310. For example, the speaker unit 310 may be disposed on the left (in the −X-axis direction) inside the speaker enclosure 330, and the air-absorbing member 340 may be disposed on the right (in the +X-axis direction) inside the speaker enclosure 330.

According to an embodiment, when air inside the internal resonance space 320 of the acoustic module 300 is compressed by vibration of the diaphragm 311 of the speaker unit 310, the air-absorbing member 340 may perform negative air absorption to minimize resistance applied to the diaphragm 311 by the air.

According to an embodiment, when air inside the internal resonance space 320 of the acoustic module 300 is relaxed and/or expanded by vibration of the diaphragm 311 of the speaker unit 310, the air-absorbing member 340 may perform positive air absorption to minimize resistance applied to the diaphragm 311 by the air.

According to an embodiment, the acoustic module 300 may further include a buffer member 350 disposed between the air-absorbing member 340 and the second enclosure housing 332. According to an embodiment, the buffer member 350 may absorb and/or suppress vibration introduced from outside the acoustic module 300. According to an embodiment, the buffer member 350 may support the air-absorbing member 340. By disposing the buffer member 350 between the air-absorbing member 340 and the speaker enclosure 330, it may be possible to minimize an amount of vibration energy transmitted to the air-absorbing member 340 through the speaker enclosure 330 and to prevent damage to the air-absorbing member 340.

According to an embodiment, the buffer member 350 may be a breathable member. By using the breathable buffer member 350, reduction in the volume of the resonance space 320 inside the speaker housing 301 may be prevented.

According to an embodiment, the buffer member 350 may include a foaming material or foaming agent (e.g. gas-foaming admixture). The foaming agent may be an agent added to a material such as rubber, plastic, or concrete to impart a sponge-like or cellular structure, and may generate bubbles to expand the material. For example, the buffer member 350 may include any one of a melamine foam or a high-density polyurethane foaming foam such as, for example, PORON®.

According to an embodiment, the acoustic module 300 may further include a first adhesive member 360 for fixing the position between the air-absorbing member 340 and the buffer member 350, and a second adhesive member 370 for fixing the position between the buffer member 350 and a lower plate of the speaker housing 301. For example, the first adhesive member 360 and the second adhesive member 370 may be adhesive materials such as adhesive tapes or bonding agents.

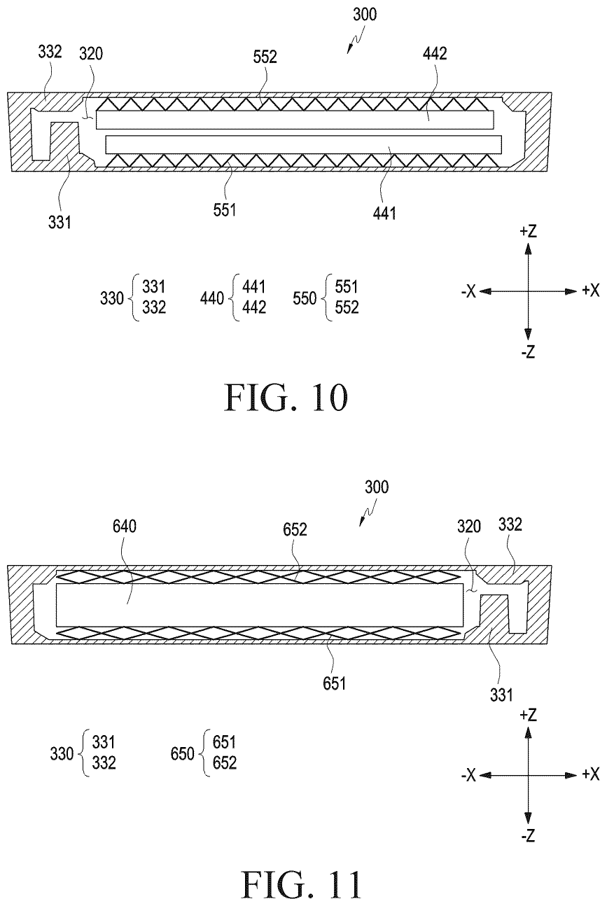

FIG. 8 is a view illustrating a molecular structure of an air-absorbing member 340 according to various embodiments of the disclosure.

According to an embodiment, the air-absorbing member 340 may be a porous member. According to an embodiment, the air-absorbing member 340 may have a fine structure that facilitates adsorption and/or desorption of nitrogen and oxygen constituting air. Referring to FIG. 8, the air-absorbing member 340 according to an embodiment of the disclosure may include a mixture including particles and a binder, the molecular structure of which is configured to perform both adsorption and desorption of air.

According to an embodiment, the air-absorbing member 340 may include a zeolite composite. According to an embodiment, the air-absorbing member 340 may be configured by mixing a binder with at least one selected from granular activated carbon, powdered activated carbon, or ARCP, which are activated carbon-based materials. According to an embodiment, the air-absorbing member 340 may be configured by mixing a binder with particles including, but not limited to, copper (Cu), zirconium (Zr1, Zr2), or aluminum (Al), which have a metal-organic framework (MOF) structure. According to an embodiment, the air-absorbing member 340 may be configured by mixing a binder with at least one selected from diatomaceous earth-based elements, perlite or silicon dioxide-based elements, or zeolite-based elements. According to an embodiment, the air-absorbing member 340 may be configured to have a specific surface area greater than that of a single solid. The air-absorbing member 340 may have a structure capable of increasing adsorption efficiency for specific elements such as nitrogen (N₂) and/or oxygen (O₂) constituting air. According to an embodiment, the air-absorbing member 340 may include an activated carbon polymer and a porous surface polymer structure having a metal-organic framework structure.

According to an embodiment, in order to overcome the effects caused by a limited space during the movement of the diaphragm 311 of the speaker unit 310 inside the acoustic module 300, the air-absorbing member 340, which facilitates adsorption and desorption of air, may be disposed in the resonance space 320 inside the acoustic module 300 so as to minimize reproduction resistance caused by air (e.g., movement resistance of the diaphragm 311) during speaker playback. By minimizing air resistance inside the acoustic module 300, the movement of the diaphragm 311 may become smoother and may ensure performance.

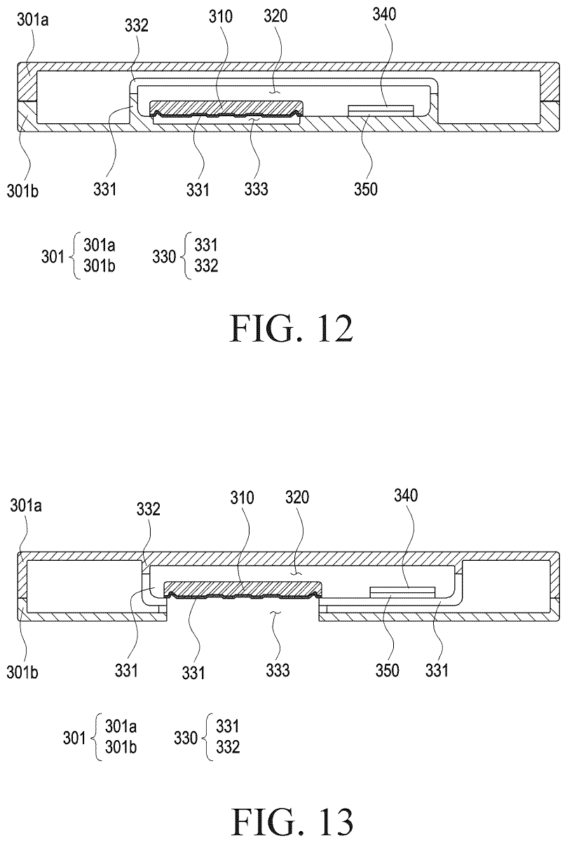

FIGS. 9 to 11 are cross-sectional views illustrating an air-absorbing member 340 and a buffer member 350 inside an acoustic module 300 according to an embodiment disclosed herein.

Referring to FIGS. 9 to 11, an electronic device 101 may include a housing 301 and an acoustic module 300 disposed inside the housing 301. The configurations of the housing 301 and the acoustic module 300 illustrated in FIGS. 5 to 7 may be entirely or partially the same as the configurations of the housing 301 and the acoustic module 300 illustrated in FIGS. 5 to 7. The structure of FIGS. 9 to 11 may optionally be combined with the structure of FIGS. 5 to 7.

According to an embodiment, the air-absorbing members 440 and 540 may include a first air-absorbing member 441 or 541 disposed on a first enclosure housing 331, and a second air-absorbing member 442 or 542 disposed on a second enclosure housing 332. The first air-absorbing member 441 or 541 and the second air-absorbing member 442 or 542 may face each other.

According to an embodiment, the buffer members 450, 550, and 650 may include a first buffer member 451 or 551 disposed between the first enclosure housing 331 and the first air-absorbing member 441 or 541, and a second buffer member 452 or 552 disposed between the second enclosure housing 332 and the second air-absorbing member 442 or 542. When the number of air-absorbing members 440 and 540 increases, the effect of minimizing reproduction resistance caused by air (e.g., movement resistance of the diaphragm 311) may be enhanced compared to the case where only one air-absorbing member is provided (e.g., FIG. 6).

According to an embodiment, referring to FIG. 9, the buffer member 450 may have a rectangular parallelepiped shape similar in size to the air-absorbing member 340.

According to an embodiment, referring to FIG. 10, the buffer member 550 may be formed of a film material to reduce its volume. The buffer member 550 made of the film material may have a folded shape alternately folded in a first direction and a second direction opposite to the first direction. For example, the buffer member 550 made of the film material may be arranged in a zigzag (W-shaped) folded form. When folded in a zigzag shape, air may flow through empty spaces formed between the folded portions.

According to an embodiment, referring to FIG. 11, the buffer member 650 may be configured in the form of a plurality of pouches that form empty spaces therein. For example, the buffer member 650 may have a pocket-type shape containing air. For example, the buffer member 650 may have a structure surrounding both an upper surface and a lower surface of the air-absorbing member 640. For example, the buffer member 650 may include a (1-1)^{th} buffer member 651 disposed on the lower surface of the air-absorbing member 640, and a (1-2)^{th} buffer member 652 disposed on the upper surface of the air-absorbing member 640.

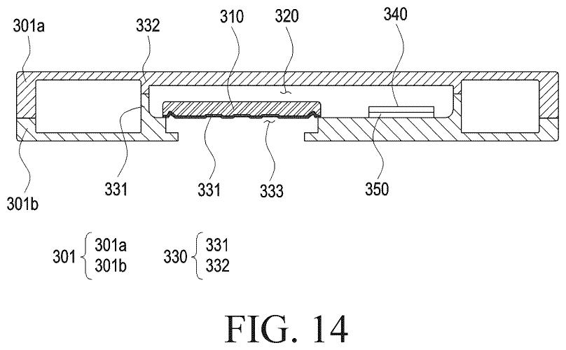

FIGS. 12 to 14 are cross-sectional views illustrating a portion of an electronic device in which a speaker enclosure 330 and a housing 301 are integrally formed according to an embodiment disclosed herein.

Referring to FIGS. 12 to 14, the electronic device 101 may include a housing 301 and an acoustic module 300 disposed inside the housing 301. The configurations of the housing 301 and the acoustic module 300 illustrated in FIGS. 12 to 14 may be entirely or partially the same as the configurations of the housing 301 and the acoustic module 300 illustrated in FIGS. 5 to 11. The structure of FIGS. 12 to 14 may be selectively combined with the structure of FIGS. 5 to 11.

According to an embodiment, the speaker enclosure 330 and the housing 301 of the electronic device may be integrally formed. According to an embodiment, referring to FIG. 12, a first enclosure housing 331 may be integrally formed with a second surface (or rear surface) 301b (e.g., 110B of FIG. 2) of the housing 301. A lower surface of the first enclosure housing 331 may be substantially coplanar with a lower surface of the second surface 301b. According to an embodiment, referring to FIG. 13, a second enclosure housing 332 may be integrally formed with a first surface (or front surface) 301a (e.g., 110A of FIG. 2) of the housing 301. An upper surface of the second enclosure housing 332 may be substantially coplanar with a lower surface of the second surface 301b. The lower surface of the first enclosure housing 331 may be in contact with the second surface 301b of the housing. The second surface 301b of the housing may include an opening 333 having the same size and shape as the opening 333 corresponding to the first enclosure housing 331. The opening 333 may be formed to penetrate both the first enclosure housing 331 and the second surface 301b. For example, the opening 333 may be formed at a position corresponding to a position of a diaphragm (e.g., the diaphragm 311 of FIG. 5) of the speaker unit 310. For example, the opening 333 may be covered by the diaphragm 311 and may serve as a sound output port that provides a space to facilitate vibration of the diaphragm 311 while allowing sound to be emitted to the outside of the acoustic module 300. According to an embodiment, referring to FIG. 14, the first enclosure housing 331 may be integrally formed with the second surface (or rear surface) 301b (e.g., 110B of FIG. 2) of the housing 301, and the second enclosure housing 332 may be integrally formed with the first surface (or front surface) 301a (e.g., 110A of FIG. 2) of the housing 301.

An electronic device according to an embodiment of the disclosure may include a housing (e.g., the housings 110A and 110B of FIGS. 2 to 3, the housing 201 of FIG. 4, or the housing 301 of FIGS. 12 to 14), and an acoustic module 300 disposed inside the housing 301. The acoustic module 300 may include a speaker unit 310 including a diaphragm 311, a speaker enclosure 330 accommodating the speaker unit 310, a porous air-absorbing member 340 disposed inside the speaker enclosure 330, and a breathable buffer member 350 disposed inside the speaker enclosure 330 and stacked with the air-absorbing member 340.

According to an embodiment, the speaker enclosure 330 may include a first enclosure housing 331 and a second enclosure housing 332 coupled to the first enclosure housing 331 and disposed above the first enclosure housing 331.

According to an embodiment, the acoustic module 300 may further include a resonance space 320 formed inside the speaker enclosure 330.

According to an embodiment, the air-absorbing member 340 may be configured to perform negative air absorption when air in the resonance space 320 is compressed by vibration of the diaphragm 311, and the air-absorbing member 340 may be configured to perform positive air absorption when air in the resonance space 320 expands by vibration of the diaphragm 311.

According to an embodiment, the buffer member 350 may be disposed between the air-absorbing member 340 and the speaker enclosure 330.

According to an embodiment, the buffer member 350 may include a foaming agent.

According to an embodiment, the buffer member 350 may include at least one of a melamine foam or a high-density polyurethane foaming foam such as, for example, PORON®.

According to an embodiment, the buffer member 350 may be formed of a film material.

According to an embodiment, a first adhesive member 360 may be further included between the air-absorbing member 340 and the buffer member 350, and a second adhesive member 370 may be further included between the buffer member 350 and the speaker enclosure 330.

According to an embodiment, the air-absorbing member 340 may be a mixture including particles and a binder having a molecular structure configured to perform adsorption and desorption of air.

According to an embodiment, the air-absorbing member may include any one of a zeolite composite, an activated carbon polymer, or a porous surface material having a metal-organic framework (MOF) structure.

According to an embodiment, the air-absorbing member 340 may include a first air-absorbing member 441 or 451 disposed on the first enclosure housing 331, and a second air-absorbing member 442 or 542 disposed on the second enclosure housing 332. The buffer member 350 may include a first buffer member 350 disposed between the first enclosure housing 331 and the first air-absorbing member 441 or 451, and a second buffer member 350 disposed between the second enclosure housing 332 and the second air-absorbing member 442 or 542.

According to an embodiment, the buffer member 350 may include a plurality of pouches that form empty spaces therein.

According to an embodiment, the buffer member 350 may include a (1-1)^{th} buffer member 350 disposed on an upper surface of the air-absorbing member 340, and a (1-2)^{th} buffer member 350 disposed on a lower surface of the air-absorbing member 340.

According to an embodiment, the speaker enclosure 330 may be integrally formed with the housing 301.

An electronic device according to an embodiment of the disclosure may include a housing 301 and an acoustic module 300 disposed inside the housing 301. The acoustic module 300 may include a speaker unit 310 including a diaphragm 311, a speaker enclosure 330 accommodating the speaker unit 310, a resonance space 320 formed inside the speaker enclosure 330, a porous air-absorbing member 340 disposed inside the speaker enclosure 330 and configured to perform negative air absorption or positive air absorption air in the resonance space 320 by vibration of the diaphragm 311, and a breathable buffer member 350 disposed between the air-absorbing member 340 and the speaker enclosure 330 inside the speaker enclosure 330 and including a foaming agent.

According to an embodiment, the speaker enclosure 330 may include a first enclosure housing 331 and a second enclosure housing 332 coupled to the first enclosure housing 331 and disposed above the first enclosure housing 331.

According to an embodiment, the buffer member 350 may include at least one of a melamine foam or a high-density polyurethane foaming foam such as, for example, PORON®.

According to an embodiment, the buffer member 350 may be formed of a film material.

According to an embodiment, a first adhesive member 360 may be further included between the air-absorbing member 340 and the buffer member 350, and a second adhesive member 370 may be further included between the buffer member 350 and the speaker enclosure 330.

In general, an acoustic module 300 includes an air-absorbing member 340 capable of performing negative air absorption and/or positive air absorption to ensure that vibration of a diaphragm 311 is not restricted. However, the air-absorbing member 340 may be easily damaged when vibration occurs or when pressure (external force) is applied. Although an additional structure may be provided to minimize transfer of vibration to the air-absorbing member 340, adding such an additional structure may reduce the internal volume of the speaker, thereby degrading acoustic performance.

An embodiment of the disclosure may provide an acoustic module 300 and an electronic device including the same, in which vibration of a diaphragm 311 is not restricted and air resistance applied to the diaphragm 311 may be minimized, reduced, and/or limited by using an air-absorbing member 340 that facilitates compression and expansion of air.

However, the technical problems intended to be solved by the disclosure are not limited to the aforementioned ones, and various modifications may be made without departing from the spirit and scope of the disclosure.

According to an embodiment of the disclosure, in order to overcome the effects caused by a limited space during the movement of the diaphragm 311 of the speaker unit 310 inside the acoustic module 300, the air-absorbing member 340, which facilitates adsorption and desorption of air, may be disposed in the resonance space 320 inside the acoustic module 300 so as to minimize reproduction resistance caused by air (e.g., movement resistance of the diaphragm 311) during speaker playback. By minimizing air resistance inside the acoustic module 300, the movement of the diaphragm 311 may become smoother and may ensure acoustic performance.

The effects that are capable of being obtained by the disclosure are not limited to those described above, and other effects not described above may be clearly understood by a person ordinarily skilled in the art to which the disclosure belongs based on the following description.

In the foregoing detailed description of this document, specific embodiments have been described. However, it will be evident to a person ordinarily skilled in the art that various modifications can be made without departing from the scope of the disclosure.

What is claimed is:

1. An electronic device comprising:
a housing; and
an acoustic module disposed inside the housing,
wherein the acoustic module comprises:
a speaker unit comprising a diaphragm;
a speaker enclosure accommodating the speaker unit;
a porous air-absorbing member disposed inside the speaker enclosure; and
a breathable buffer member disposed inside the speaker enclosure and stacked with the porous air-absorbing member.

2. The electronic device of claim 1, wherein the speaker enclosure comprises a first enclosure housing and a second enclosure housing coupled to the first enclosure housing and disposed above the first enclosure housing.

3. The electronic device of claim 1, wherein the acoustic module further comprises a resonance space formed inside the speaker enclosure.

4. The electronic device of claim 3, wherein the porous air-absorbing member is configured to:
perform negative air absorption when air in the resonance space is compressed by vibration of the diaphragm; and
perform positive air absorption when air in the resonance space expands by vibration of the diaphragm.

5. The electronic device of claim 1, wherein the breathable buffer member is disposed between the porous air-absorbing member and the speaker enclosure.

6. The electronic device of claim 1, wherein the breathable buffer member comprises a foaming agent.

7. The electronic device of claim 1, wherein the breathable buffer member comprises at least one of a melamine foam or a high-density polyurethane foaming foam.

8. The electronic device of claim 1, wherein the breathable buffer member is formed of a film material.

9. The electronic device of claim 1, further comprising:
a first adhesive member between the porous air-absorbing member and the breathable buffer member; and
a second adhesive member between the breathable buffer member and the speaker enclosure.

10. The electronic device of claim 1, wherein the porous air-absorbing member is a mixture comprising particles and a binder having a molecular structure configured to perform adsorption and desorption of air.

11. The electronic device of claim 1, wherein the porous air-absorbing member comprises any one of a zeolite composite, an activated carbon polymer, or a porous surface material having a metal-organic framework (MOF) structure.

12. The electronic device of claim 2, wherein the porous air-absorbing member comprises a first air-absorbing member disposed on the first enclosure housing, and a second air-absorbing member disposed on the second enclosure housing, and
wherein, when the breathable buffer member comprises a first buffer member disposed between the first enclosure housing and the first air-absorbing member, and a second buffer member disposed between the second enclosure housing and the second air-absorbing member.

13. The electronic device of claim 1, wherein the breathable buffer member comprises a plurality of pouches forming empty spaces therein.

14. The electronic device of claim 1, wherein the breathable buffer member comprises a (1-1)^{th} buffer member disposed on an upper surface of the porous air-absorbing member, and a (1-2)^{th} buffer member disposed on a lower surface of the porous air-absorbing member.

15. The electronic device of claim 1, wherein the speaker enclosure is integrally formed with the housing.

16. An acoustic module comprising:
a speaker unit including a diaphragm;
a speaker enclosure accommodating the speaker unit and defining a resonance space in which vibration of the diaphragm causes compression and expansion of air;
a porous air-absorbing member disposed inside the speaker enclosure and configured to adsorb the air; and
a breathable buffer member disposed in contact with the porous air-absorbing member and configured to suppress vibration applied to the porous air-absorbing member.

17. The acoustic module of claim 16, wherein the porous air-absorbing member is configured to absorb the air in response to compressing the air in the resonance space by vibration of the diaphragm and to desorb the air in response to expanding the air in the resonance space by vibration of the diaphragm.

18. The acoustic module of claim 17, wherein the porous air-absorbing member minimizes a movement resistance of the diaphragm.

19. The acoustic module of claim 17, wherein the breathable buffer member suppresses the vibration applied to the porous air-absorbing member while allowing the air to pass therethrough.

20. The acoustic module of claim 19, wherein the breathable buffer member comprises a foaming material.
